(19) United States
(12) Patent Application Publication
(10) Pub. No.: US 2006/0162232 A1
(43) Pub. Date: Jul. 27, 2006

(54) Fishing apparatus and method

(76) Inventor: Rodney Allen, Middletown, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/044,803

(22) Filed: Jan. 27, 2005

(51) Int. Cl. A01K 85/00

(52) U.S. Cl. 43/42.36

(57) ABSTRACT

The present invention relates to fishing, and more specifically, provides a fishing lure and method for attracting a fish to strike an artificial lure. The present invention is further adapted to enhance the likelihood of setting the hook in the fish once the fish strikes the lure. One embodiment of the present invention provides a fishing lure with an elongated soft body where the soft body is attached to the fishing line at an intermediate portion, and the lure contains at least one hook positioned near one of the soft body free ends.

### FIELD OF THE INVENTION

This invention relates generally to the art and sport of fishing, and more particularly to an improved artificial fishing lure and method for rigging and using the same to help fishermen attract and catch more fish.

### BACKGROUND OF THE INVENTION

Fishing has long been an invaluable means and source for gathering food needed to survive. More than that, however, over the years fishing has also transformed into a sport activity as well as an art form centered around finding the best way or ways on any given day to attract and catch fish of differing species. From the earliest times, live bait fishing has been considered by many to be most productive, relying upon the use of living or dead bait such as minnows, worms, frogs, crawdads, bugs or the like. It was understood that the shapes, scents, tastes and actions of these live baits were central to their attracting ability. The fishermen need only find suitable ways to incorporate one or more hooks into the live bait rig, which were hoped to detract as little as possible from their live action while also providing the means to catch the fish when it bites.

Over time, fishing was also revolutionalized with the introduction and tremendous growth in the use of artificial baits in place of natural or live ones. These artificial baits are many times designed and constructed to closely resemble such live bait arrangements, and at other times are designed more abstractly, presumably more as an attractant or irritant intended to cause more aggressive predator fish to bite. While artificials take on many shapes, sizes and materials, both hard and soft, the introduction of plastic, flexible-bodied artificial baits has expanded the art of fishing even more. Regardless of their intended shape or form, many such plastic baits incorporate a lead end attached to the fishing line and a trailing end or ends incorporating some form of lifelike movement or action. Somewhere in the body also secured to the fishing line will be one or more hooks intended to be taken into the fish's mouth when it bites and provide a solid hook-up when the fisherman jerks back on his rod to set the hook and thereby catch the fish.

While plastic artificial baits have taken on many shapes and forms, including those resembling living creatures and those not, by far such baits intended to simulate a worm or worm-like creature have been the most successful and longest lived. Traditionally, such plastic worms are most often rigged to appear as if they are swimming or otherwise moving through the water in a straight line. However, in another age-old style or method of fishing that has taken on increasing popularity in recent years, the angler impales a single hook of some type through the center or middle portion of an elongated worm-like bait. The purpose of this, often referred to as a “Wacky Worm”-form of fishing, is to give the bait a natural slow falling look or presentation in the water while also allowing its outer ends to droop and dangle or otherwise move about simulating the action of a live worm wiggling around on the end of a hook. An example of such a “Wacky Worm”-style rig is depicted as artificial lure 110 in FIG. 1. As lure 110 is pulled through the water by its fishing line in the direction of 142, its hook 120, attached near the middle of its soft plastic body, 115 pulls that body along, thereby allowing its ends to dangle and move around freely in the water. One significant drawback with such arrangements is the tendency for a fish to strike one or both of the moving ends and to not take hook 120 into its mouth while biting. If this occurs, when the fisherman feels the bite and jerks his rod intending to set the hook in the fish's mouth, the bait will instead be ripped away from the fish usually scaring it away. While the fisherman may be able to allow the fish more time during the bite to take in all of the body including the hook, this may not be possible for any number of reasons. Therefore, it is commonly known that “Wacky Worm”-style fishing tends to result in a lot of missed hook-ups that significantly detract from its use as an everyday fishing style. Still another drawback associated with this situation is that the soft body 115 may easily be pulled off hook 120 when the fisherman jerks, thereby losing the plastic bait entirely.

Consequently, there is a need for an improved artificial fishing lure and method of rigging and using the same in a “Wacky Worm”-style that takes advantage of the realistic action and attractant of a flexible soft plastic body as it dangles from its central point of attachment and moves through the water. At the same time, the need exists to increase the ability of fishermen to achieve a solid hook-up once the fish strikes the lure even if only at one of its free ends. Certain preferred features of the present invention address these and other needs and provide other important advantages as will be apparent below.

### SUMMARY OF THE INVENTION

Preferred embodiments of the present invention provide a fishing lure that attracts fish to bite and become ensnared by the lure.

In one embodiment of the present invention, an artificial fishing lure is comprised of an elongated body having a first free end, an oppositely-disposed second free end and an intermediate portion between the first and second free ends. The artificial fishing lure also comprises a first fishing hook having a pointed end, where the first fishing hook is attached to the elongated body near the first free end. An attachment member is constructed and arranged for connection to a fishing line. The attachment member is then attached to the intermediate portion of the elongated body and to the first fishing hook and the elongated body thereby provides live action characteristics and increased hook-up ability during fishing.

In another embodiment of the present invention, a fishing lure is provided for attachment to a fishing line and movement through water, and is comprised of an elongated member with first and second opposing free ends and an intermediate body portion between the two opposing free ends. A first fishing hook is further provided and is comprised of a pointed end which is attached to the first opposing free end. Additionally, a connecting means is used for securing the first fishing hook to the fishing line, wherein the connecting means allows the two free ends to dangle from the intermediate body portion resembling lifelike motion as the fishing lure is pulled through the water.

In yet another embodiment of the present invention, a method for fishing is disclosed by providing a lure with an elongated body, a first hook and an attachment member, wherein the elongated body has an intermediate portion and two free ends. The first hook is positioned near one free end, and the attachment member is positioned near the intermediate portion. The method further includes attaching the attachment member to a fishing line, attaching the first hook to the attachment member, and moving the lure through the water in a manner that allows the two free ends to dangle from the intermediate portion.

Further objects, features and advantages of the present invention shall become apparent from the detailed drawings and descriptions provided herein.

### BRIEF DESCRIPTION OF THE DRAWINGS

FIG. 1 is a fragmentary, front elevational view of a fishing lure according to one prior art design.

FIG. 2 is a fragmentary, front elevational view of a fishing lure according to one embodiment of the present invention at-rest.

FIG. 3 is a fragmentary, front elevational view of the FIG. 2 fishing lure as deployed in a body of water.

FIG. 4 is a fragmentary, front elevational view of a fishing lure according to another embodiment of the present invention as deployed in a body of water.

FIG. 5 is a fragmentary, front elevational view of a fishing lure according to yet another embodiment of the present invention as deployed in a body of water.

FIG. 6 is a fragmentary, front elevational view of a fishing lure according to still another embodiment of the present invention as deployed in a body of water.

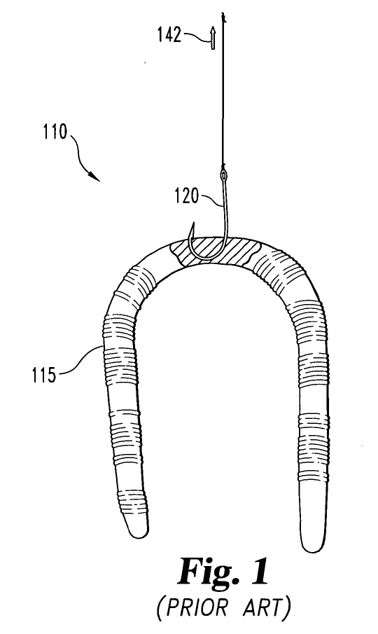

### DETAILED DESCRIPTION OF THE ILLUSTRATED EMBODIMENTS

For the purposes of promoting an understanding of the principles of the invention, reference will now be made to the embodiments illustrated and specific language will be used to describe the same. It will nevertheless be understood that no limitation of the scope of the invention is thereby intended, such alterations, modifications, and further applications of the principles of the invention being contemplated as would normally occur to one skilled in the art to which the invention relates.

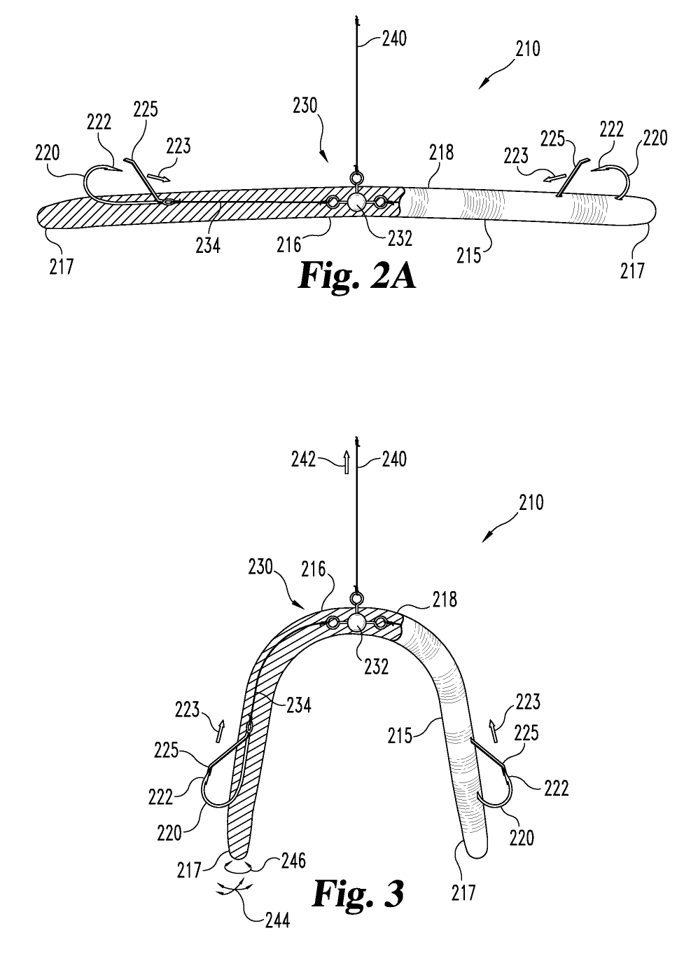

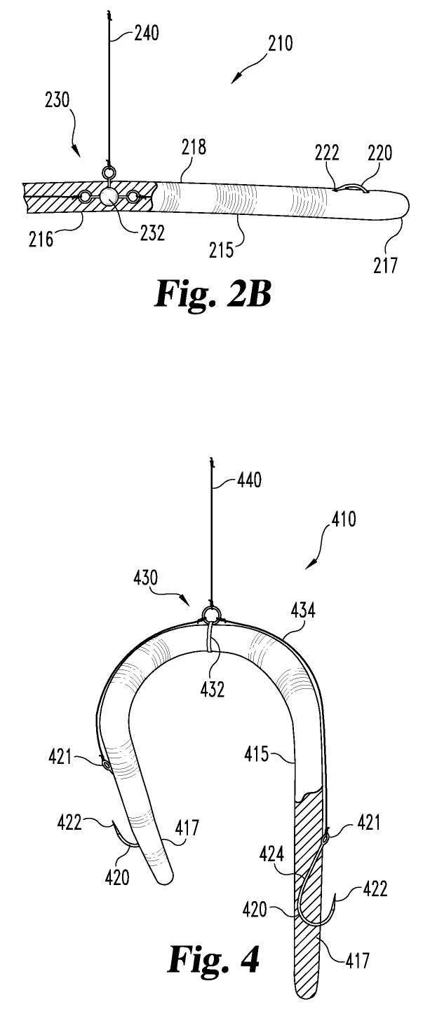

Referring now to FIGS. 2 and 3, therein is illustrated a pre-rigged artificial fishing lure 210 that is constructed and arranged to resemble a worm-like creature according to one embodiment of the present invention. Lure 210 is generally depicted in FIG. 2 in a flat, at-rest position, where lure 210 tends to return to its original generally linear shape. Lure 210 according to this embodiment includes elongated soft plastic body 215, two hooks 220 preferably shown with points 222 and weed guards 225 partially exposed from the body 215, and a fishing line attachment member generally depicted by numeral 230. More particularly, the preferred soft plastic body 215 includes an intermediate or center body portion 216, two opposing free ends 217, and a general outer surface 218 formed and textured to simulate the appearance of a worm or worm-like creature. In turn, portions of hooks 220, weed guards 225, and attachment member 230 are preferably embedded within soft body 215 during the molding and rigging process. By so doing, these embedded portions will not detract in any way from the overall live worm-like appearance and feel of lure 210, especially when taken into the fish's mouth during a bite.

Referring now to preferred attachment member 230, it includes swivel mechanism 232 and flexible leader line 234 for connecting hooks 220 through to fishing line 240 during use. In this way, hooks 220 are securely fastened to fishing line 240 to permit the angler to fight and land a fish after a bite and hook-up have occurred, while also allowing ends 217 of body 215 to move and dangle freely in the water exhibiting live action characteristics as the lure is fished. By way of example, these live action movements are generally represented by translational direction arrows 244 and rotational direction arrows 246 in FIG. 3. The ends 217 of the lure thereby generally move around freely in the water within the material constraints of the soft plastic body 215 itself and within any rigidity constraints associated with the fishing line attachment member 230.

Although preferred attachment member 230 includes swivel mechanism 232, which is configured as a three-way swivel, and leader line 234 as depicted in FIG. 2, other attachment means and members may be used as long as they provide a secure attachment between hooks 220 and line 240 while retaining the capability of allowing ends 217 of the bait to bend, flex, twist, wiggle and otherwise move freely in the water during use. Alternate example embodiments of attachment member 230 include monofilament line, clips and other swivel designs. By way of example only, if attachment member 230 were not to include its own swivel mechanism 232, a separate external swivel such as are common and well-known in the art could first be attached to the end of fishing line 240 and then secured to the non-swiveling attachment member 230 in order to allow for greater movement of the lure while preventing excess twisting or entanglement. Similarly, other acceptable means may be used for attaching hooks 220 to fishing line 240 in a pre-rigged arrangement such as preferred lure 210 so long as the attachment is secure and acceptable movement is retained. Certain of these, for example, as in the case of a preassembled Snell-type rig, may even not require hooks 220 to have standard eyelets such as those depicted in FIGS. 2 and 3 and identified by numeral 421 in FIG. 4.

In the preferred method of constructing or pre-rigging lure 210, hooks 220 and attachment member 230 are arranged in an appropriate mold such as those commonly used in the field and the soft plastic body 215 of the lure 210 is formed around this structure. The preferred molding arrangement in this embodiment is such that points 222 of hooks 220 are exposed and extend through outer surface 218 of plastic body 215 near or adjacent each free end 217 of the body. This preferred arrangement significantly improves the likelihood of successful hook-ups when fish bite as compared to traditional “Wacky Worm”-style lures where the hook is only secured and exposed near the middle of the plastic body. The precise location of hooks 220 near the ends 217 of the body in preferred lure 210 can vary according to several factors, such as the individual length of each free end and the overall configuration and intended action the lure is to simulate. In any case, having the hooks attached to the body generally at or adjacent its free ends is important to accomplish the improved hook set according to the present invention. In the embodiment illustrated in FIG. 2, hooks 220 are also arranged such that their respective hook point face directions 223 are toward the intermediate portion 216 of the body and fishing line attachment member 230. These hook point directions 223 are also generally in the lure movement direction 242 as soft body 215 bends while lure 210 is twitched, pulled, and otherwise retrieved through the water by the angler as depicted in FIG. 3.

Still further, preferred hooks 220 may emerge from body 215 at various angles relative to outer surface 218 and with various portions of their overall gape exposed. In order to help guard against hanging up on various bottom or free-floating structures such as weeds, rocks, logs and the like, while still having hooks 220 capable of imbedding in a fish's mouth during a bite and jerk, preferred hooks 220 have guards 225 as discussed above which are in the form of a bent wire ahead of the hooks themselves. Other types of weed guards commonly known and used in the art can equally work in this arrangement. Similarly, having hook points 222 lay more closely against the side of soft body 215 or even having such points 222 partially imbedded in the soft body are alternative means as well, so long as they do not interfere too much in the hooking action.

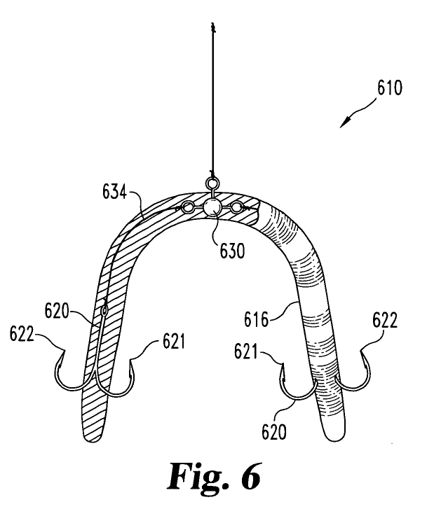

Referring now to preferred swivel mechanism 230 depicted in FIGS. 2 and 3, swivel mechanism 230 may comprise any number of conventional swivels or clips known in the art to be useful in such arrangements depending upon the particular construction and action of the lure intended. For example, while a three-way swivel is depicted, also acceptable would be a four-way swivel with the fourth ring exposed toward the inside or the underside of the bent soft body 215 opposite the fishing line attachment. This fourth ring could be used for various purposes such as tying on a drop line for added weight or for a spinner, rattle or other attachment in an attempt to increase the attracting power of the lure. Still other alternate embodiments of preferred lure 210 may utilize only one hook 220 arranged in one free end, or may utilize two or more hooks 220 arranged in each free end 217 of body 215 as in the case of very long lure shapes. Still other acceptable embodiments of lure 210 may utilize double hooks such as shown in FIG. 6 or even treble hook arrangements such as those known in the art. In still further embodiments, the entirety of at least one of hooks 220 and leader line 234 may not be molded within body 215, but instead may be held alongside with the hooks attached near the ends by passing them partially through the plastic as shown in FIG. 4 or by use of any other conventional means such as simply tying them onto the body using additional line, rubber bands or the like.

Preferred embodiments of lure 210 are constructed such that they are sufficiently light and suited for shallow water fishing with a slow falling and quiet entering presentation. Other preferred embodiments of lure 210 are heavier, resist skipping, and fall through the water column quicker, providing advantages such as enhancing the ability to catch fish near the lake or stream bottom. In still further embodiments, lure 210 is “Carolina rigged” as is know in the art with a sinker bead, swivel, and a leader attached to lure 210.

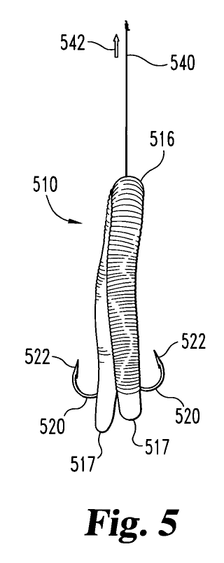

Different types of fish may strike a bait differently—some may swallow the bait whole while others may bite at one end. As discussed above, there is also frequently a need to guard the hooks so that the lure does not hang up on obstacles, such as rocks or weeds, near the fish. Alternate embodiments of the present invention utilize different hook orientations to satisfy these and other needs. Referring to the orientation of hooks 220 in body 216 as depicted in FIG. 3, hook points 222 extend outwardly from soft body 216 and generally toward the outside of lure 210 as it bends and free ends 217 droop while being pulled through the water in direction 242. This orientation allows hooks 222 to be readily set in a striking fish's mouth, and may be particularly useful in hooking a fish that swallows lure 210 whole. Other preferred embodiments utilize different hook orientations to accomplish these goals. For example, the hook orientations depicted in FIG. 5 typically provide good hook-up for fish that either swallow lure 510 whole or bite an end, while providing some amount of protection from getting snagged on underwater obstacles due to the hooks 520 not being oriented on the outside of bent lure 510. In still further embodiments, lures using only hooks that are oriented to the inside of the lure, such as inward hook points 621 in FIG. 6, provided a greater amount of protection from getting snagged on underwater obstacles and yet still provide adequate hook-up for a fish striking one end of lure 610.

Soft body 215 is preferably comprised of some plastic or other synthetic polymeric materials that are generally flexible, pliable, capable of lifelike movements and capable of being molded into various lifelike shapes, such as worms, lizards, salamanders, snakes and frogs. Fishing line attachment member 230 is preferably constructed and arranged so as to not break loose from the rest of the lure when bitten by and reeling in a fish, and may be constructed of materials generally known in the art, such as metal. Hook 222 is preferably constructed of materials that will withstand the bite of a fish and generally maintain its hook shape as the fish is reeled in, such as various types of metals. Typical examples of hook sizes, shapes, and materials can be found by referring to the EagleClaw® (http://www.eagleclaw.com/) and O. Mustad & Sons A.S. (http://www.mustad.no/) websites.

Referring now to FIG. 4, therein is illustrated another example embodiment pre-rigged fishing lure 410 constructed and arranged to resemble a worm-like creature with fishing line attachment member 430 arranged externally to soft body 415. Fishing lure 410 includes fishing line attachment member 430 and hooks 420. Fishing line attachment member 430 includes soft body engagement portion 432 that secures fishing line attachment member 430 to soft body 415 and further includes two hook engagement portions 434 that engage hooks 420. Due to a majority of the rigging hardware being external to soft body 415, lure 410 is typically constructed by assembling lure 410 after soft body 415 is formed. Hooks 420 are embedded in soft body 415 by piercing soft body 415 with hook point 422 and threading hook 420 through soft body 415 into the depicted orientation.

Soft body engagement portion 432 is depicted as a band securing attachment member 430 to soft body 415. Other alternate embodiments of preferred lure 410 may utilize at least two soft body engagement portions 432 to secure multiple portions of attachment member 430 to soft body 415 while maintaining flexibility in soft body 415 and allowing free ends 417 to move freely in the water exhibiting live action characteristics as the lure is fished. Still other alternate embodiments of preferred lure 410 may use other engagement mechanisms to secure attachment member 430 to body 415 while preserving the ability of free ends 417 to dangle with lifelike motion. Example additional engagement mechanisms include tying attachment member 430 to soft body 415 with fishing line or rubber bands, or having a screw-like device attached to member 430 and screwed into soft body 415.

Referring now to hooks 420, hooks 420 are partially embedded in soft body 415 with eyelet 421 and hook point 422 being exposed and a significant portion of the hook shank and bend being embedded in soft body 415. In contrast to hooks 220, hooks 420 do not include barbs at hook points 422, which is common in many circumstances.

Fishing line attach member further includes two hook engagement portions 434 that are tied to hooks 420 and are comprised of leader line. Other alternate embodiments of engagement portion 434 provide a secure attachment between engagement portions 434 and hooks 420 while allowing lure 410 to move with lifelike motion while fishing. Example alternate embodiments of engagement portion 434 include monofilament line, swivels and clips. Although depicted as attaching to eyelet 421, engagement portion 434 may alternatively attach to another portion of hook 420, such as by being glued to shank 424. In still other embodiments, hooks 420 may be attached to engagement portions 434 using Snell-type rigs or other methods that are commonly known in the art.

In the illustrated embodiment, fishing line 440, while being attached to intermediate body portion 216, is not attached to the exact center point between the tips of the two free ends 417. This asymmetric dangling arrangement can enhance the independent movement of free ends 417 and enhance the lure's ability to attract fish.

Referring to FIG. 5, there is illustrated another embodiment lure 510 of the current invention depicted in a bent configuration with the free ends dangling as lure 510 is pulled through water in direction 542. In the illustrated embodiment, soft body 516 includes free ends 517 and embedded hooks 520, each with a barbed hook point 522. In contrast to lure 410 in FIG. 4, the fishing line attachment member of lure 510 is embedded entirely within soft body 516. In order to allow the angler to attach lure 510 to fishing line 540, a slit in body 516 or other means that allows exposure of at least a portion of the attachment member to facilitate attachment to fishing line 540 is provided. Once attached, the slit can be closed, thereby closing the attachment member back within soft body 516.

Referring to FIG. 6, therein is illustrated yet another embodiment fishing lure 610, depicted in a bent configuration with the free ends dangling as if it were being pulled through water. In the illustrated embodiment, double hooks 620, leader lines 634 and fishing line attachment member 630 are once again preferably embedded in soft body 616 during the molding process. Double hooks 620 each include two hook points. Outward hook points 622 are displaced outwardly and toward the outside of the bent lure 610 in the figure, while inward hook points 621 are displaced inwardly and toward the inside of the bent lure 610. However, as discussed above, the soft and flexible nature of body 616 means that the position and orientation of all the hook points will vary during movement through water.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. Dimensions are not intended to be limiting and may be altered as would be understood by one of ordinary skill in the art.

1. An artificial fishing lure, comprising:
an elongated soft body having a first free end, an oppositely-disposed second free end and an intermediate portion between said first and second free ends;
a first fishing hook having a pointed end, wherein said first fishing hook is embedded in said elongated soft body near said first free end;
an attachment member constructed and arranged for connection to a fishing line, said member attached to said intermediate portion of said elongated soft body and attached to said first fishing hook; and,
wherein said elongated soft body thereby provides live action characteristic motion and increased hook-up ability during fishing.

2. The fishing lure of claim 1, wherein said pointed end is embedded in said elongated soft body.

3. The fishing lure of claim 1, wherein said attachment member is substantially embedded in said elongated soft body.

4. The fishing lure of claim 1, wherein said elongated soft body includes a length between said first and second free ends, and further includes a cross-sectional area normal to said length, wherein said cross-sectional area is substantially constant along said length.

5. The fishing lure of claim 4, wherein said elongated soft body defines a worm-like shape.

6. The fishing lure of claim 1, wherein said elongated soft body is a single and integrated member.

7. The fishing lure of claim 1, wherein said attachment member includes a leader line.

8. The fishing lure of claim 1, wherein said attachment member includes a swivel.

9. The fishing lure of claim 1, wherein said elongated soft body flexes when pulled through water with said intermediate body portion leading said first and second free ends in the direction of motion.

10. The fishing lure of claim 1, further comprising a second fishing hook having a pointed end, wherein said second fishing hook is attached to said elongated soft body near said second free end and further attached to said attachment member.

11. The fishing lure of claim 10, wherein said elongated soft body bends when pulled in a direction of motion through the water with said first and second hook points pointing generally in said direction of motion.

12. The fishing lure of claim 1 further comprising an anti-fouling member, wherein said anti-fouling member is adapted to decrease the likelihood of said first hook becoming attached to an object other than a fish.

13. A fishing lure for attachment to a fishing line and movement through water, comprising:
an elongated soft member with first and second opposing free ends and an intermediate body portion between said two opposing free ends;
a first fishing hook with a pointed end, said first fishing hook embedded in said first opposing free end; and,
connecting means for securing said first fishing hook to the fishing line, wherein said connecting means allows said two free ends to dangle from said intermediate body portion resembling lifelike motion as the fishing lure is pulled through the water.

14. The fishing lure of claim 13 further comprising a second fishing hook with a pointed end, wherein said second hook is attached to said second opposing free end.

15. The fishing lure of claim 14, wherein said first hook pointed end points in a first hook point direction and said second hook pointed end points in a second hook point direction, and wherein each said hook point direction is oriented approximately toward said intermediate body portion when the fishing lure is at rest.

16. The fishing lure of claim 15, wherein said first hook pointed end points in a first hook point direction and said second hook pointed end points in a second hook point direction, and wherein each said hook point direction is approximately in the direction of motion of the lure as the lure moves through the water.

17. The fishing lure of claim 14, wherein said first and second hook pointed ends are embedded in said elongated soft member.

18. A method for fishing, comprising:
providing a lure with an elongated soft body, a first hook and an attachment member, wherein the elongated soft body has an intermediate portion and two free ends;
attaching the attachment member to the elongated soft body intermediate portion;
embedding the first hook in the elongated soft body near one free end;
attaching the attachment member to a fishing line;
attaching the first hook to the attachment member; and,
moving the lure through the water in a manner that allows the two free ends to dangle from the intermediate portion.

19. The method of claim 18, wherein said providing includes a second hook, and further comprising:
embedding the second hook in the elongated soft body near a free end different from that which the first hook is positioned near; and
attaching the second hook to the attachment member.

20. The method of claim 19, wherein each hook has a hook point direction, and said moving results in both hook point directions aligning generally with the direction of lure movement when the lure is pulled through water by the fishing line, and both hook point directions generally pointing toward the intermediate portion when the lure is at rest.

21. The method of claim 19, wherein the attachment member is embedded in the elongated soft body.

22. The method of claim 18, wherein the elongated soft body defines a worm-like shape.
